(19) United States
(12) Patent Application Publication
(10) Pub. No.: US 2006/0190915 A1
(43) Pub. Date: Aug. 24, 2006

(54) Machine specific and machine group correction of masks based on machine subsystem performance parameters

(76) Inventors: Adlai H. Smith, Escondido, CA (US); Robert O. Hunter JR., Snowmass Village, CO (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/336,296

(22) Filed: Jan. 19, 2006

Related U.S. Application Data
(60) Provisional application No. 60/645,468, filed on Jan. 19, 2005.

(51) Int. Cl. G06F 17/50

(52) U.S. Cl. 716/19; 716/4

(57) ABSTRACT

Determining corrections for a mask used in photolithography includes assembling characteristics of a mask design and an as-drawn specification into a virtual reticle. Assembling characteristics of machine subsystem parameters into a virtual wafer. Emulating machine performance on the virtual reticle and virtual wafer and accumulating the results in an updated virtual wafer. Comparing metrics of the updated virtual wafer to the as-drawn specification and if the comparison meets or exceeds a desired threshold, then incorporating mask clips of the virtual reticle into a final mask design, if the comparison does not meet the desired threshold, then calculating mask corrections, updating the virtual reticle, and repeating emulating and comparing.

### REFERENCE TO PRIORITY DOCUMENT

This application claims priority benefit of U.S. Provisional Patent Application Ser. No. 60/645,468 filed Jan. 19, 2005 entitled “Machine Specific and Machine Group Correction of Masks Based on Machine Subsystem Performance Parameters” by Smith et al. Priority of the filing date of the prior application is hereby claimed, and the disclosure of the prior application is hereby incorporated by reference in its entirety.

### BACKGROUND

1. Field of the Invention

The present invention generally relates to semiconductor manufacturing and more specifically to the correction of photomasks to enhance semiconductor yield within a fab.

2. General Background

Low K1 (<0.5) lithography with acceptable yields is becoming the norm. As feature sizes continue to decrease, sources of error and variation that were previously acceptable have become critical. While scanner performance has improved, the layer to layer performance within a single machine as well as the machine to machine variation still pose obstacles to mass production.

There is a need for methods and apparatus for improving the layer to layer performance in photolithography within a single machine as well as reducing machine to machine variation.

### SUMMARY

Masks that are used in photolithography present an opportunity to help overcome or at least ameliorate the aforementioned difficulties. While masks are generally designed to compensate for diffraction effects they do so only for otherwise perfect machines i.e., machines devoid of aberrations and source inhomogenities. These latter effects contribute to layer to layer and machine to machine mismatches. Accurate in-situ techniques that can characterize aberrations (see, for example, Smith et al., “Apparatus, Method of Measurement and Method of Data Analysis for Correction of Optical System”, U.S. Pat. No. 5,828,455, Oct. 27, 1998; and Smith et al., “Apparatus, Method of Measurement and Method of Data Analysis for Correction of Optical System”, U.S. Pat. No. 5,978,085, Nov. 2, 1999) and the source (see, for example, McArthur et al., “In-Situ Source Metrology Instrument and Method of Use”, U.S. Pat. No. 6,356,345, Mar. 12, 2002; and McArthur et al., “In-Situ Source Metrology Instrument and Method of Use”, U.S. Pat. No. 6,741,338, May 25, 2004) can be used in combination with a simulation engine to emulate mask performance (see, for example, Smith et al., “Method of Emulation of Lithographic Projection Tools”, U.S. Patent Publication No. US-2005-0240895-A1, Oct. 27, 2005). The present invention is directed to the application of these techniques to mask correction in a manufacturing environment.

In one embodiment, corrections for a mask used in photolithography are determined, including operations of assembling characteristics of a mask design and an as-drawn specification into a virtual reticle, assembling characteristics of machine subsystem parameters into a virtual wafer, emulating machine performance on the virtual reticle and virtual wafer and accumulating the results in an updated virtual wafer, and comparing metrics of the updated virtual wafer to the as-drawn specification such that, if the comparison meets or exceeds a desired threshold, then incorporating mask clips of the virtual reticle into a final mask design and, if the comparison does not meet the desired threshold, then calculating mask corrections, updating the virtual reticle, and repeating emulating and comparing in accordance with the desired threshold or other stopping criteria, such as a pass/fail criteria.

The characteristics of the mask design may have undergone optical proximity corrections, and the characteristics of the mask design may also include control points. The as-drawn specification may include identification of critical dimensions and their allowable range of variation. The machine subsystem parameters may include, for example, lens aberration, lens exit pupil transmission, lens distortion, light source structure, stage synchronization error and repeatability, flare, vibration, and photoresist development parameters. The virtual wafer may include a wafer serial number, wafer size, and a flatness profile. The desired threshold may be based upon at least one critical dimension. In addition, calculating mask corrections and updating the virtual reticle can include simulating annealing, or mask error enhancement.

Other features and advantages of the present invention should be apparent from the following description of exemplary embodiments, which illustrate, by way of example, aspects of the invention.

### BRIEF DESCRIPTION OF THE DRAWINGS

FIG. 1 shows a process flow for an exemplary embodiment for mask correction.

FIG. 2 shows a rectangle (possibly tilted) CD variable type (control point) description for use in an exemplary mask adjustment process.

FIG. 3 shows an exemplary polygon vertex (Var Type=PV) variable type description for use in mask.

FIG. 4 shows a sample mask clip including OPC correction and central points; in this example the OPC controls are CD values only.

FIG. 5 shows a sample as-drawn specification for isolation pattern.

FIG. 6 shows an example of a blank virtual wafer VW with general wafer file and flatness profile.

FIG. 7 shows an example of an initial virtual wafer, VW, with additional process/layer ID, machine settings, and flatness profile.

FIG. 8 shows an example of an updated virtual wafer, VW, after performing machine emulation.

### DETAILED DESCRIPTION

In one embodiment, a method of determining corrections for a mask used in photolithography includes assembling characteristics of a mask design and an as-drawn specification into a virtual reticle and assembling characteristics of machine subsystem parameters into a virtual wafer. Machine performance on the virtual reticle and virtual wafer are emulated and the results are accumulated in an updated virtual wafer. The next operation involves comparing metrics of the updated virtual wafer to the as-drawn specification such that, if the comparison meets or exceeds a desired threshold, then mask clips of the virtual reticle are incorporated into a final mask design, and if the comparison does not meet the desired threshold, then mask corrections are calculated, the virtual reticle is updated, and emulating and comparing are repeated in accordance with the desired threshold. The desired threshold is generally a stopping criteria or pass/fail criteria.

The characteristics of the mask design may have undergone optical proximity corrections. The characteristics of the mask design may also include control points. The as-drawn specification may include identification of critical dimensions and their allowable range of variation. The machine subsystem parameters may include, for example, lens aberration, lens exit pupil transmission, lens distortion, light source structure, stage synchronization error and repeatability, flare, vibration, and photoresist development parameters. The virtual wafer may include a wafer serial number, wafer size, and a flatness profile. The desired threshold may be based upon at least one critical dimension. In addition, calculating mask corrections and updating the virtual reticle can include simulating annealing, or mask error enhancement.

In another embodiment, a method of determining corrections for a mask used in photolithography includes assembling characteristics of a mask design and an as-drawn specification into a virtual reticle, assembling characteristics of machine subsystem parameters into a virtual wafer and repeating assembling characteristics of machine subsystem parameters into virtual wafers for each machine within a group of machines, emulating machine performance on the virtual reticle and all of the virtual wafers of the group of machines and accumulating the results in updated virtual wafers, comparing metrics of the updated virtual wafers to the as-drawn specification and, if the comparison meets or exceeds a desired threshold, then incorporating mask clips of the virtual reticle into a final mask design and, if the comparison does not meet the desired threshold, then calculating mask corrections, updating the virtual reticle, and repeating emulating and comparing.

In one embodiment, a projection imaging tool may include an illumination source, and a corrected mask, and the corrections to the mask may be determined by assembling characteristics of a mask design and an as-drawn specification into a virtual reticle, assembling characteristics of machine subsystem parameters into a virtual wafer, emulating machine performance on the virtual reticle and virtual wafer and accumulating the results in an updated virtual wafer, comparing metrics of the updated virtual wafer to the as-drawn specification and, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.

In another embodiment, a projection imaging tool within a group of projection imaging tools may include an illumination source, and a corrected mask. The corrections to the mask may be determined by assembling characteristics of a mask design and an as-drawn specification into a virtual reticle, assembling characteristics of machine subsystem parameters into a virtual wafer, repeating assembling characteristics of machine subsystem parameters into virtual wafers for each machine within a group of machines, emulating machine performance on the virtual reticle and all of the virtual wafers of the group of machines and accumulating the results in updated virtual wafers, comparing metrics of the updated virtual wafers to the as-drawn specification and, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.

In yet another embodiment, a data processing system for determining corrections for a mask used in photolithography may include storage means for storing characteristics of a mask design, as-drawn specifications, and a machine subsystem. The system includes a processor adapted to assemble the characteristics of a mask design and as-drawn specification into a virtual reticle, and assemble characteristics of machine subsystem parameters into a virtual wafer. The processor then emulates machine performance on the virtual reticle and virtual wafer and accumulates the results in an updated virtual wafer. The processor compares metrics of the updated virtual wafer to the as-drawn specification. If the comparison meets or exceeds a desired threshold, then incorporating mask clips of the virtual reticle into a final mask design, if the comparison does not meet the desired threshold, then calculating mask corrections, updating the virtual reticle, and repeating emulating and comparing.

In still another embodiment, a data processing system for determining corrections for a mask used in photolithography may include storage means for storing characteristics of a mask design, as-drawn specifications, and a machine subsystem. A processor is adapted to assemble characteristics of a mask design and an as-drawn specification into a virtual reticle, assemble characteristics of machine subsystem parameters into a virtual wafer, repeat the assembling characteristics of machine subsystem parameters into virtual wafers for each machine within a group of machines, emulate machine performance on the virtual reticle and all of the virtual wafers of the group of machines and accumulating the results in updated virtual wafers, comparing metrics of the updated virtual wafers to the as-drawn specification and, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.

In one embodiment, a program product for use in a computer device includes a computer-readable media having recorded computer-readable program instructions for execution by the computer device to perform a method for determining corrections for a mask used in photolithography. The program instructions are executable by the computer device to assemble characteristics of a mask design and an as-drawn specification into a virtual reticle, assemble characteristics of machine subsystem parameters into a virtual wafer, emulate machine performance on the virtual reticle and virtual wafer and accumulate the results in an updated virtual wafer, compare metrics of the updated virtual wafer to the as-drawn specification and, if the comparison meets or exceeds a desired threshold, then incorporate mask clips of the virtual reticle into a final mask design, and if the comparison does not meet the desired threshold, then calculate mask corrections, update the virtual reticle, and repeat emulating and comparing.

In still another embodiment, a program product for use in a computer device includes a computer-readable media having recorded program instructions to perform a method for determining corrections for a mask used in a group of photolithographic machines. The program product includes a recordable media, and a plurality of computer-readable instructions executable by the computer device to assemble characteristics of a mask design and an as-drawn specification into a virtual reticle, assemble characteristics of machine subsystem parameters into a virtual wafer, repeat assembling characteristics of machine subsystem parameters into virtual wafers for each machine within a group of machines, emulate machine performance on the virtual reticle and all of the virtual wafers of the group of machines and accumulate the results in updated virtual wafers, compare metrics of the updated virtual wafers to the as-drawn specification and, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.

Process

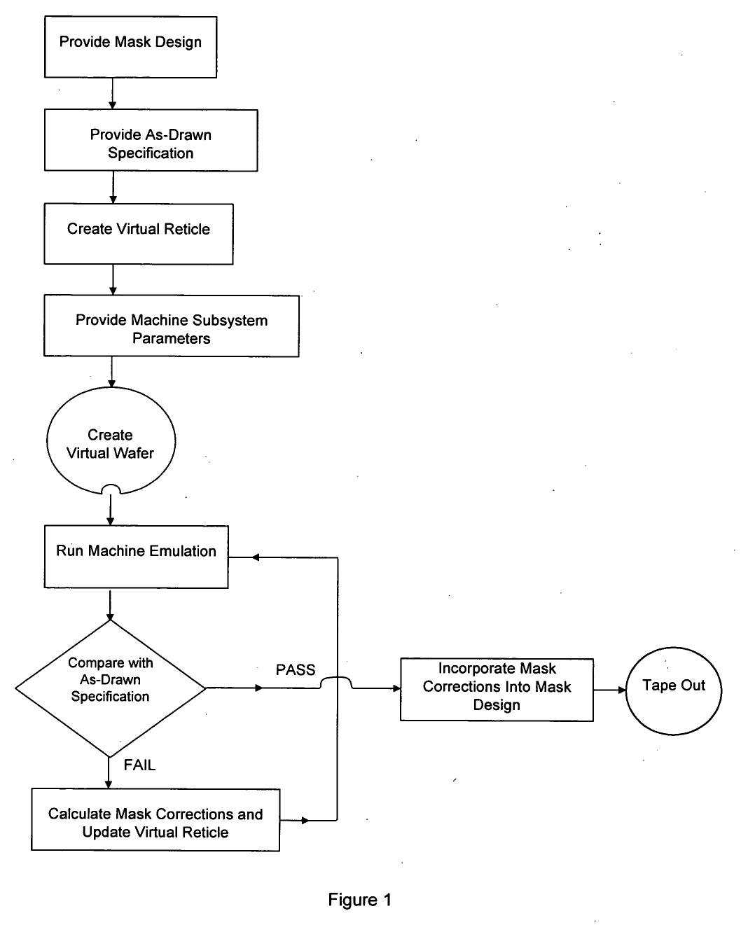

A method that operates in accordance with the invention is as sketched in FIG. 1. The first operation shown is that of providing a mask design, and the method concludes with a tapeout procedure. The operations will be described further below.

Provide Mask Design

The first operation of FIG. 1 is to provide a mask design. A mask design geometry file, such as a GDS-II file, is generally provided. Those skilled in the art will be familiar with data files commonly used for specification of mask design geometries in conjunction with fabrication processes. Hierarchy in the file is important for minimizing computations. This is the mask layout as desired on the reticle; it does not include corrections (e-beam or optical proximity effects, sideways resist development) required for actually manufacturing the mask. Because of existing ECAD software, the effects of diffraction by itself will have nominally been accounted for in this design. Put differently, it is anticipated that the provided mask design will have optical proximity effects already taken into account and perform adequately on perfect machines.

Hierarchy is inherent in mask layouts for ease of design and as a means for data compression. Mask cells, representing repeated features are numerically described in detail within a data structure and the identity of that same data structure is instanced in regard to its location on the mask. Therefore, we can typically readily identify and access individual mask cells within the GDS-II (or other ECAD format) file.

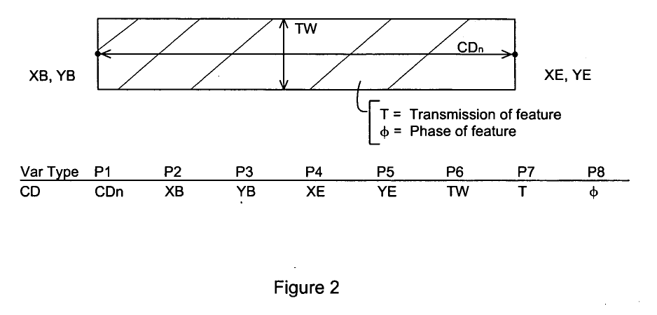

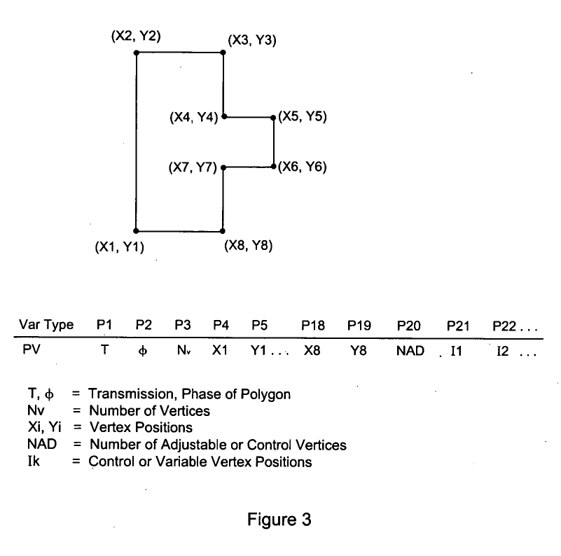

Another point is that because we are using a mask file that has already been subject to optical proximity corrections (OPC) the control points or location and interpretation of variable parameters that define where OPC has already been performed (see, for example, Cobb et al., “Mathematical and CAD Framework for Proximity Correction”, Proc. of SPIE, Vol. 2726, p. 208, 1996 and Cobb et al., “Large Area Phase-Shift Mask Design”, Proc. of SPIE, Vol. 2197, p. 348, 1994), and therefore can be supplied along with the GDS-II file as part of the mask design. FIGS. 2 and 3 show examples in the same format of structures (CD of rectangle and polygon) that are varied in the OPC process. So, at this point, we will have been given a GDS-II file and listing of control points that are varied in the correction process.

Provide As-Drawn Specification

The next operation shown in FIG. 1 is to provide as-drawn specifications. It should be understood that the as-drawn specification is the desired printed pattern on the wafer along with identification of critical parameters and their allowable range of variation. A desired printed pattern is an input to OPC calculations (see, for example, Cobb et al., “Fast, Low-Complexity Mask Design”, Proc. of SPIE, Vol. 2440, p. 313, 1995; “Mathematical and CAD Framework for Proximity Correction”, supra, “Large Area Phase-Shift Mask Design”, supra and Pati et al., “Phase-Shifting Masks: Automated Design and Mask Requirements”, Proc. of SPIE, Vol. 2197, p. 314, 1994) and so is typically available (it is output of ECAD software). Identification of critical structures and their associated tolerance may also be done in the OPC software; it is typically part of the input and subsequent OPC calculations. Manufacturing tolerances may be “looser” than mask design tolerances (because they are just one component of the manufacturing tolerance) and the user will need to edit or revise them, but their instance and location will have already been determined.

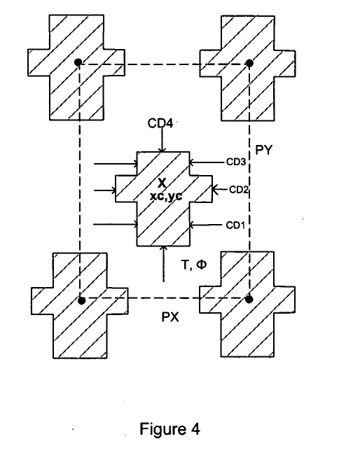

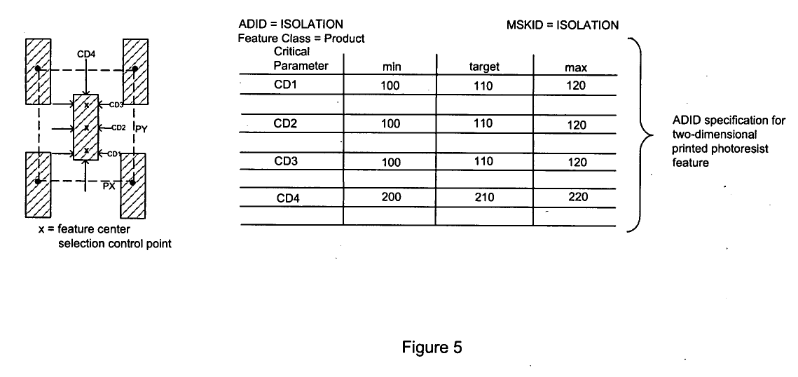

FIG. 4 shows a sample mask clip including OPC and control points while FIG. 5 shows a sample as-drawn clip and identified critical structures with target values and ranges for the critical parameters.

Create Virtual Reticle

At this point we can assemble the mask clips, as drawn clips and as drawn specifications, into a virtual reticle (VR). This is described in, for example, U.S. Patent Publication No. US-2005-0240895-A1, supra. The virtual reticle is used in the subsequent machine calculations. Control point file specified in mask design is not incorporated into the VR.

Provide Machine Subsystem Parameters

This is an input for designing manufacturable masks; gathering data on real lithography machine subsystems. As discussed in, for example, U.S. Patent Publication No. US-2005-0240895-A1, supra, measured subsystem parameters include lens aberrations, lens exit pupil transmission, lens distortion, light source structure, stage synchronization error and repeatability, flare, vibration, and photoresist development parameters. The mask that is being optimized will be for a specific lithographic layer of a specific process. This means some set of specific process conditions (e.g., NA, illumination, photoresist, exposure dose) will have been specified in the development stage of the process cycle and are now available to define the nominal machine settings (i.e., the machine specific identifiers) used in manufacturing this layer. This information is incorporated into a virtual wafer file structure along with the process/layer name (ID) and the process/layer wafer flatness profile. The flatness profile is typically set=0 for mask optimization but could include repeatable process induced variations. These are all combined within the framework discussed in, for example, U.S. Patent Publication No. US-2005-0240895-A1, supra; this framework provides a consistent and detailed picture of projection imaging machines as characterized by their subsystem performances.

Create Initial Virtual Wafer

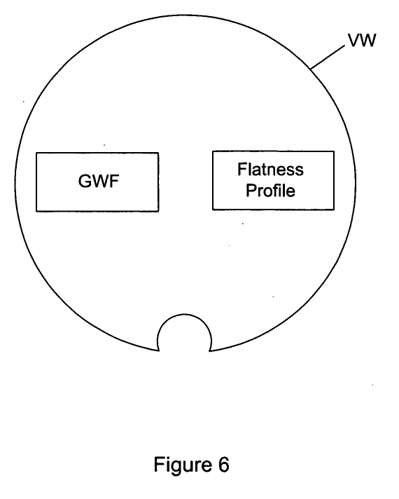

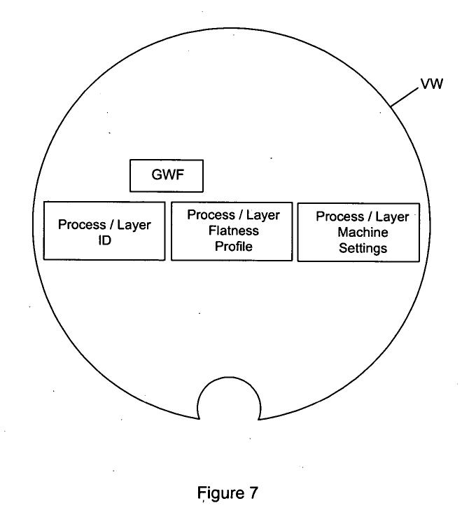

Following the emulation framework outlined in, for example, U.S. Patent Publication No. US-2005-0240895-A1, supra, we now create an initial virtual wafer (VW). First the general wafer file (GWF) containing serial number, notch, size, and product layout as a text file is provided followed by an initial flatness profile. The initial flatness profile will typically be set=0 for mask optimization runs. Blank virtual wafer, VW, at this stage is shown in FIG. 6. The virtual wafer then is adapted with additional processes, such as layer ID, machine settings, and flatness profiles, as shown in FIG. 7.

Run Machine Emulation

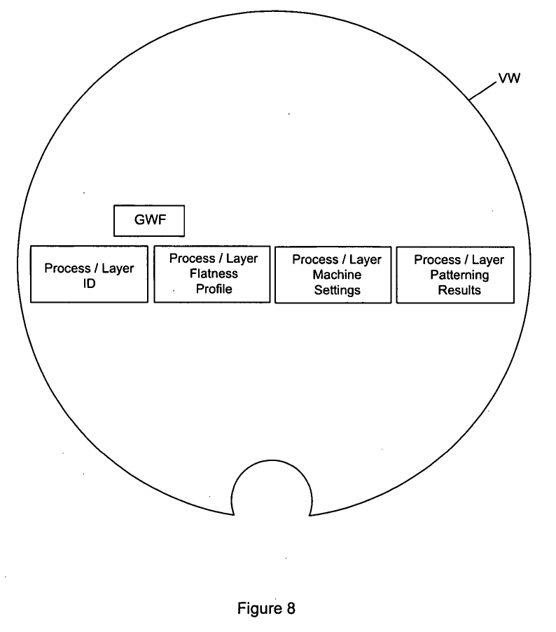

Now, and following the teachings of, for example, U.S. Patent Publication No. US-2005-0240895-A1, supra, we run the machine emulation. The output of this step is accumulated in VW (see FIG. 8).

Compare With As-Drawn Specification

At this point we compare with the as-drawn specification contained in virtual reticle, VR. There are several metrics we could utilize, one being:

$$ECD = \frac{1}{{N}_{CD}} {\sum }_{a = 1}^{NCD} {[ \frac{{CD}_{AD}^{( a )} - {CD}_{AD}^{req} ( a )}{Δ {CD}_{AD}^{req} ( a )} ]}^{2 P} \qquad Equation 1$$

where:

N_{CD}=number of CD critical parameters

CD_{AD}^{(a)}=CD as reported in updated virtual wafer (FIG. 8)

CD_{AD}^{req}, ΔCD_{AD}^{req}=required, range of CD as contained in virtual reticle

P=norming parameter≧½
Equation 1 only refers to CD but because each term is normalized by the allowed variation (ΔCD^{req}) we could easily generalize it to include other process results such as wall angle, resist loss, edge shift, feature center shift, etc. Alternatively, we could have several net indices of this type for each of the aforementioned process results. A third alternative would have an index like E_{CD} (or a combined CD, overlay, etc. index) for each mask clip. Whatever metric we choose, the pass/fail criteria for the entire mask will be of the form:

$$\begin{matrix}{E}_{ CD} \leq {E}_{ CD}^{ th} & pass mask \\ > {E}_{CD}^{th} & fail mask\end{matrix} \qquad Equation 2$$

where the threshold or decision index E_{CD}^{th}≈1. If the mask passes by evaluation of Equation 2, then the input virtual reticle mask clips are incorporated into a final mask design and a new GDS-II mask file is generated (Tape-Out in FIG. 1). Failure at this stage means we proceed with another mask iteration.
Calculate Mask Corrections and Update Virtual Reticle

There are several strategies for doing this, some of which are:
Simulated annealing. Useful when the number of mask parameters/cell is large. Here the merit function is quadratic or higher power of difference from nominal.
MEEF, Mask error enhancement factor. This is preferred. We calculate linear response of CDs to changes in relevant mask CDs as:

$$Δ {CD}_{AD} = \frac{\partial {CD}_{AD}}{\partial {CD}_{1}} Δ {CD}_{1} + \frac{\partial {CD}_{AD}}{\partial {CD}_{2}} Δ {CD}_{2} + ⋯ + \frac{\partial {CD}_{AD}}{\partial {CD}_{n}} Δ {CD}_{n} \qquad Equation 3$$

where the partial derivatives

$$\frac{\partial {CD}_{AD}}{\partial {CD}_{1}} ,$$

. . . etc., are computed by multiple calls to the emulator. CD_{AD}=CD of as-drawn or as desired feature. So, for a number of critical dimensions within a mask cell we would have the set of equations:

$$Δ {CD}_{AD} ( a ) = {\sum }_{j = 1}^{NM} \frac{\partial {CD}_{AD} ( a )}{\partial {CD}_{j}} Δ {CD}_{j} \\ a = 1 \text{:} NP \qquad Equation 4$$

The merit function is:

$$E = \frac{1}{NP} {\sum }_{a = 1}^{NP} {( \frac{{CD}_{AD} ( a ) + {\sum }_{j = 1}^{Nm} \frac{\partial {CD}_{AD} ( a )}{\partial {CD}_{j}} Δ {CD}_{j} - {CD}_{AD}^{req} ( a )}{Δ {CD}_{AD}^{req} ( a )} )}^{2 P} \qquad Equation 5$$

where:

CD_{AD}(a)=critical feature CDs on the last iteration

$$\frac{\partial {CD}_{AD}}{\partial {CD}_{j}} = influence coefficients calculated in calls to emulator$$

CD_{AD}^{req}(a)=target CDs

ΔCD_{AD}^{req}(a)=allowable or target range for CD_{AD}(a).

When P=1 we can optimize the mask shifts ΔCDⱼ, using standard least squares algorithms. However, if we want to more strongly penalize out of specification (e.g., >ΔCD_{AD}^{req}) variations we could select a merit function with P>1 and minimize E using Levenburg Marquant or simulated annealing. What simplifies the process of mask adjustment is that as successive mask cells (as defined in virtual reticle) come within the required specification bounds, they need no longer be updated. Another factor that greatly diminishes the number of required computations is that a given, specific mask cell need only be computed with a spatial frequency of ≦1 mm at the wafer level. Put differently, since the subsystem variations across the projection field (˜26×33 mm²) are apparent only on scales that are ≧1 mm, in our initial virtual reticle specification we need not include instances of mask cells closer than this. Now, since a mask cell is typically ≦10 μm in size, this results in ≧10,000× speedup over exhaustive looping. To correct the mask cells at intermediate sites, we merely interpolate our mask correction results. Now, manufacturable masks generally are laid out on an approximately 10 nm grid and therefore the final output will be snapped or otherwise constrained by this grid. At the iteration stage, before we interpolate our results to directly unoptimized sites, we will save our corrections to the initial mask design as continuous values not constrained by the grid. Put differently, we allow positional variation of the mask control points at a level ≦ 1/100 of the manufacturing grid. Only after our iterative loop is completed and we are interpolating the corrections to all sites on the mask do we snap the control points to the 10 nm mask manufacturing grid. This is followed by tapeout.

Further Discussion

What has been so far discussed focused on mask correction for a single specific machine. If we want to use a group of machines, the discussion changes in no essential way except that now, each machine has a separate virtual wafer and all of these virtual wafers are emulated and the result used to best correct the mask for this machine group.

So far, single mask optimization has been discussed. Dual mask approaches (see, for example, “Phase-Shifting Masks: Automated Design and Mask Requirements”, supra) for printing low K1 features exist. One change to this discussion is that now instead of a single virtual reticle, two virtual reticles would be required. The other change is that our emulator would need to be capable of utilizing two virtual reticles.

In the flow diagram of FIG. 1, the information flow between the separate blocks can be managed by an executive software module. That is, the operations illustrated in FIG. 1 and described above can occur under the control of a computer that executes program instructions to perform the method of FIG. 1. The computer can receive the program instructions through a program product, such as a recordable media on which are recorded computer-readable program instructions that can be executed by the computer to perform the method described above and illustrated in FIG. 1. The recordable media can include memory devices such as flash memory and removable media devices such as optical and magneto-optical discs. The operations can be implemented in a computer-controlled projection imaging tool or the like, or a data processing system for determining corrections for a mask used in photolithography.

The foregoing description details certain embodiments of the invention. It will be appreciated, however, that no matter how detailed the foregoing appears, the invention may be embodied in other specific forms without departing from its spirit or essential characteristics. The described embodiments are to be considered in all respects only as illustrative and not restrictive and the scope of the invention is, therefore, indicated by the appended claims rather than by the foregoing description. All changes, which come with the meaning and range of equivalency of the claims, are to be embraced within their scope.

We claim:

1. A method of determining corrections for a mask used in photolithography, the method comprising:
assembling characteristics of a mask design and an as-drawn specification into a virtual reticle;
assembling characteristics of machine subsystem parameters into a virtual wafer;
emulating machine performance on the virtual reticle and virtual wafer and accumulating the results in an updated virtual wafer; and
comparing metrics of the updated virtual wafer to the as-drawn specification such that, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.

2. A method as defined in claim 1, wherein the characteristics of the mask design have undergone optical proximity corrections.

3. A method as defined in claim 1, wherein the characteristics of the mask design includes control points.

4. A method as defined in claim 1, wherein the as-drawn specification includes identification of critical dimensions and their allowable range of variation.

5. A method as defined in claim 1, wherein the machine subsystem parameters includes lens aberration.

6. A method as defined in claim 1, wherein the machine subsystem parameters includes lens exit pupil transmission.

7. A method as defined in claim 1, wherein the machine subsystem parameters includes lens distortion.

8. A method as defined in claim 1, wherein the machine subsystem parameters includes light source structure.

9. A method as defined in claim 1, wherein the machine subsystem parameters includes stage synchronization error.

10. A method as defined in claim 1, wherein the machine subsystem parameters includes stage repeatability.

11. A method as defined in claim 1, wherein the machine subsystem parameters includes stage flare.

12. A method as defined in claim 1, wherein the machine subsystem parameters includes stage vibration.

13. A method as defined in claim 1, wherein the machine subsystem parameters includes photoresist development parameters.

14. A method as defined in claim 1, wherein the virtual wafer includes a wafer serial number.

15. A method as defined in claim 1, wherein the virtual wafer includes a wafer size.

16. A method as defined in claim 1, wherein the virtual wafer includes a flatness profile.

17. A method as defined in claim 1, wherein the desired threshold is based upon at least one critical dimension.

18. A method as defined in claim 1, wherein calculating mask corrections and updating the virtual reticle further comprises simulating annealing.

19. A method as defined in claim 1, wherein calculating mask corrections and updating the virtual reticle further comprises mask error enhancement.

20. A method of determining corrections for a mask used in photolithography, the method comprising:
assembling characteristics of a mask design and an as-drawn specification into a virtual reticle;
assembling characteristics of machine subsystem parameters into a virtual wafer;
repeating assembling characteristics of machine subsystem parameters into virtual wafers for each machine within a group of machines;
emulating machine performance on the virtual reticle and all of the virtual wafers of the group of machines and accumulating the results in updated virtual wafers; and
comparing metrics of the updated virtual wafers to the as-drawn specification such that, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.

21. A projection imaging tool comprising:
an illumination source; and
a corrected mask, wherein the corrections to the mask are determined by assembling characteristics of a mask design and an as-drawn specification into a virtual reticle, assembling characteristics of machine subsystem parameters into a virtual wafer, emulating machine performance on the virtual reticle and virtual wafer and accumulating the results in an updated virtual wafer, and comparing metrics of the updated virtual wafer to the as-drawn specification such that, if the comparison meets or exceeds a desired threshold, then mask clips of the virtual reticle are incorporated into a final mask design, and if the comparison does not meet the desired threshold, then mask corrections are calculated, the virtual reticle is updated, and emulating and comparing are repeated.

22. A projection imaging tool within a group of projection imaging tools, the projection imaging tool comprising:
an illumination source; and
a corrected mask, wherein the corrections to the mask are determined by assembling characteristics of a mask design and an as-drawn specification into a virtual reticle, assembling characteristics of machine subsystem parameters into a virtual wafer, repeating assembling characteristics of machine subsystem parameters into virtual wafers for each machine within a group of machines, emulating machine performance on the virtual reticle and all of the virtual wafers of the group of machines and accumulating the results in updated virtual wafers, and comparing metrics of the updated virtual wafers to the as-drawn specification such that, if the comparison meets or exceeds a desired threshold, then mask clips of the virtual reticle are incorporated into a final mask design, and if the comparison does not meet the desired threshold, then mask corrections are calculated, the virtual reticle is updated, and emulating and comparing are repeated.

23. A data processing system for determining corrections for a mask used in photolithography, the method comprising:
storage means for storing characteristics of a mask design, as drawn specifications, and a machine subsystem;
a processor adapted to assemble the characteristics of a mask design and as-drawn specification into a virtual reticle, and assemble characteristics of machine subsystem parameters into a virtual wafer, then emulate machine performance on the virtual reticle and virtual wafer and accumulate the results in an updated virtual wafer, and compare metrics of the updated virtual wafer to the as-drawn specification such that, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.

24. A data processing system for determining corrections for a mask used in photolithography, the method comprising:
storage means for storing characteristics of a mask design, as drawn specifications, and a machine subsystem;
a processor adapted to assemble characteristics of a mask design and an as-drawn specification into a virtual reticle, assemble characteristics of machine subsystem parameters into a virtual wafer, and repeat the assembling characteristics of machine subsystem parameters into virtual wafers for each machine within a group of machines, emulate machine performance on the virtual reticle and all of the virtual wafers of the group of machines and accumulating the results in updated virtual wafers; and compare metrics of the updated virtual wafers to the as-drawn specification such that, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.

25. A program for use in a computer device that executes program instructions recorded in a computer-readable media to perform a method for determining corrections for a mask used in photolithography, the program comprising:
a recordable media; and
a plurality of computer-readable instructions executable by the computer device to perform a method comprising
assembling characteristics of a mask design and an as-drawn specification into a virtual reticle,
assembling characteristics of machine subsystem parameters into a virtual wafer,
emulating machine performance on the virtual reticle and virtual wafer and accumulating the results in an updated virtual wafer, and
comparing metrics of the updated virtual wafer to the as-drawn specification such that, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.

26. A program for use in a computer device that executes program instructions recorded in a computer-readable media to perform a method for determining corrections for a mask used in a group of photolithographic machines, the program comprising:
a recordable media; and
a plurality of computer-readable instructions executable by the computer device to perform a method comprising
assembling characteristics of a mask design and an as-drawn specification into a virtual reticle,
assembling characteristics of machine subsystem parameters into a virtual wafer,
repeating assembling characteristics of machine subsystem parameters into virtual wafers for each machine within a group of machines,
emulating machine performance on the virtual reticle and all of the virtual wafers of the group of machines and accumulating the results in updated virtual wafers, and
comparing metrics of the updated virtual wafers to the as-drawn specification such that, if the comparison meets or exceeds a desired threshold, then incorporating mask clips of the virtual reticle into a final mask design, and if the comparison does not meet the desired threshold, then calculating mask corrections, updating the virtual reticle, and repeating emulating and comparing.
